(19) United States
(12) Patent Application Publication
(10) Pub. No.: US 2004/0185327 A1
(43) Pub. Date: Sep. 23, 2004

(54) High performance ceramic anodes and method of producing the same

(76) Inventors: Raymond J. Gorte, Narberth, PA (US); John M. Vohs, Newtown Square, PA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/735,857

(22) Filed: Dec. 16, 2003

Related U.S. Application Data
(60) Provisional application No. 60/433,588, filed on Dec. 16, 2002.

(51) Int. Cl. H01M 4/86; H01M 4/96; H01M 4/88

(52) U.S. Cl. 429/45; 502/101

(57) ABSTRACT

The present invention generally relates to high performance anodes for use in solid oxide fuel cells, whereby the anodes are comprised primarily of ceramic material. The anodes are pre-treated with a hydrocarbon having more than one carbon atom such that carbonaceous deposits form on the anode material.

1. Field of the Invention

The present invention relates generally to solid oxide fuel cells (SOFC) and to methods of their preparation. Specifically, the invention relates to high performance ceramic anodes and to methods of producing them whereby the ceramic anodes include deposits of hydrocarbons that are believed to improve the electrical conductivity and fuel efficiency of the fuel cell.

2. Description of Related Art

Solid oxide fuel cells have grown in recognition as a viable high temperature fuel cell technology. There is no liquid electrolyte, which eliminates metal corrosion and electrolyte management problems typically associated with the use of liquid electrolytes. Rather, the electrolyte of the cells is made primarily from solid ceramic materials that are capable of surviving the high temperature environment typically encountered during operation of solid oxide fuel cells. The operating temperature of greater than about 600° C. allows internal reforming, promotes rapid kinetics with non-precious materials, and produces high quality by-product heat for cogeneration or for use in a bottoming cycle. The high temperature of the solid oxide fuel cell, however, limits the availability of suitable fabrication materials. Because of the high operating temperatures of conventional solid oxide fuel cells (approximately 600 to 1000° C.), the materials used to fabricate the respective cell components are limited by chemical stability in oxidizing and reducing environments, chemical stability of contacting materials, conductivity, and thermomechanical compatibility.

The most common anode materials for solid oxide fuel cells are nickel (Ni)-cermets prepared by high-temperature calcination of NiO and yttria-stabilized zirconia (YSZ) powders. High-temperature calcination usually is considered essential in order to obtain the necessary ionic conductivity in the YSZ. These Ni-cermets perform well for hydrogen (H₂) fuels and allow internal steam reforming of hydrocarbons if there is sufficient water in the feed to the anode. Because Ni catalyzes the formation of graphite fibers in dry methane, it is necessary to operate anodes made using nickel at steam/methane ratios greater than one. Direct oxidation of higher hydrocarbons without the need for steam reformation is possible and described, inter alia, in U.S. Patent Application Publication Nos. 20010029231, and 20010053471, the disclosures of each of which are incorporated by reference herein in their entireties.

Because Ni is known to catalyze the formation of graphite and require steam reformation, some anodes have been prepared that do not require such high steam/methane ratios whereby an entirely different type of anode was used, either based on doped ceria (Eguchi, K, et al., Solid State Ionics, 52, 165 (1992); Mogensen, G., Journal of the Electrochemical Society, 141, 2122 (1994); and Putna, E. S., et al., Langmuir, 11 4832 (1995)) perovskite (Baker, R. T., et al., Solid State Ionics, 72, 328 (1994); Asano, K., et al., Journal of the Electrochemical Society, 142, 3241 (1995); and Hiei, Y., et al., Solid State Ionics, 86-88, 1267 (1996)), LaCrO₃ and SrTiO₃ (Doshi, R., et al., J. Catal. 140, 557 (1993); Sfeir, J., et al., J. Eur. Ceram. Cos., 19, 897 (1999); Weston, M., et al., Solid State Ionics, 113-115, 247 (1998); and Liu, J., et al., Electrochem. & Solid-State Lett., 5, A122 (2002), or copper based anodes (U.S. Patent Application Publication Nos. 20010029231, and 20010053471, the disclosures of which are incorporated by reference herein in their entirety). Replacement of Ni for other metals, including Co (Sammnes, N. M., et al., Journal of Materials Science, 31, 6060 (1996)), Fe (Bartholomew, C. H., CATALYSIS REVIEW-Scientific Engineering, 24, 67 (1982)), Ag or Mn (Kawada, T., et al., Solid State Ionics, 53-56, 418 (1992)) also has been considered.

Based on the catalytic properties of various electronic conductors that could be used in the anode, Cu-based anodes have been developed for use in SOFC (S. Park, et al., Nature, 404,265 (2000); R. J. Gorte, et al., Adv. Materials, 12,1465 (2000); S. Park, et al., J. Electrochem. Soc., 146, 3603 (1999); S. Park, et al., J. Electrochem. Soc., 148, A443 (2001); and H. Kim, et al., J. Am. Ceram. Soc., 85,1473 (2002). Compared to Ni, Cu is not catalytically active for the formation of C-C bonds. Its melting temperature, 1083° C., is low compared to that of Ni, 1453° C.; however, for low-temperature operation, (e.g., <800° C.), Cu is likely to be sufficiently stable.

Because Cu₂O and CuO melt at 1235 and 1326° C., respectively, temperatures below that necessary for densification of YSZ electrolytes, it is not possible to prepare Cu-YSZ cermets by high-temperature calcination of mixed powders of CuO and YSZ, a method analogous to that usually used as the first step to produce Ni-YSZ cermets. An alternative method for preparation of Cu-YSZ cermets was therefore developed in which a porous YSZ matrix was prepared first, followed by addition of Cu and an oxidation catalyst in subsequent processing steps (R. J. Gorte, et al., Adv. Materials, 12,1465 (2000); S. Park, et a., J. Electrochem. Soc., 148, A443 (2001)). Because the Cu phase in the final cermet must be highly connected, high metal loadings are necessary; and, even then, connectivity between all Cu particles in the anode structure is not assured.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

It would be desirable to provide a solid oxide fuel cell that has high fuel efficiency, electrical conductivity, high power, and is capable of directly oxidizing hydrocarbons. It also would be desirable to provide anode materials, and methods of preparing the anode materials for use in solid oxide fuel cells, whereby the materials are capable of direct oxidation of hydrocarbons and can be fabricated at lower temperatures. A feature of an embodiment of the invention therefore is to provide a solid oxide fuel cell that has high fuel efficiency, electrical conductivity, high power, and is capable of directly oxidizing hydrocarbons. It is an additional feature of an embodiment of the invention to provide anode materials, methods of making the anode materials, and methods of making the solid oxide fuel cells.

In accordance with these and other features of various embodiments of the present invention, there is provided an anode comprising a porous ceramic material, at least an additional ceramic material that may be the same or different from the porous ceramic material, a metal, or both, and at least one carbonaceous compound formed by exposing the anode material to a hydrocarbon having more than one carbon atom.

In accordance with an additional feature of an embodiment of the invention, there is provided a method of making an anode comprising forming a porous ceramic material, adding at least an additional ceramic material that may be the same or different from the porous ceramic material, a metal, or both to the porous ceramic material, and contacting the resulting mixture with a hydrocarbon having greater than one carbon atom for a period of time sufficient to form carbonaceous deposits on the anode material.

In accordance with another feature of an embodiment of the invention, there is provided a solid oxide fuel cell comprising a solid electrolyte, a cathode material, and an anode comprising a porous ceramic material, at least an additional ceramic material that may be the same or different from the porous ceramic material, a metal, or both, and at least one carbonaceous compound formed by exposing the anode to a hydrocarbon having more than one carbon atom.

In accordance with yet another feature of an embodiment of the invention, there is provided a method of making a solid oxide fuel cell comprising forming a porous ceramic material having at least two opposing surfaces, contacting one of the surfaces with a cathode material, and contacting the opposing surface with an anode material. The anode material includes at least an additional ceramic material that may be the same or different from the porous ceramic material, a metal, or both. The anode material thus formed after the contacting is exposed to a hydrocarbon having greater than one carbon atom for a period of time sufficient to form carbonaceous deposits on the anode.

These and other features and advantages of the preferred embodiments will become more readily apparent when the detailed description of the preferred embodiments is read in conjunction with the attached drawings.

### BRIEF DESCRIPTION OF THE DRAWINGS

FIG. 1 is a schematic illustrating the changes in the three phase boundary of an anode of the present invention (a) before and (b) after exposure to n-butane.

FIG. 2 is a gas chromatogram trace obtained from the carbonaceous deposits formed on a Cu-plated stainless steel following exposure to n-butane.

FIG. 3 is a graph showing the performance of an anode comprising primarily ceria before and after exposure to butane.

FIG. 4 is a graph showing the performance of the same anode of FIG. 3 in different fuels.

FIG. 5 is a graph showing the performance of a Y-doped SrTiO₃-ceria anode before and after exposure to butane.

FIG. 6 is a graph showing the performance of a Sr-doped LaCrO₃ anode before and after exposure to butane.

FIG. 7 is a graph showing the effect of the calcination temperature of ceria on the anode performance.

### DETAILED DESCRIPTION OF THE PREFERRED EMBODIMENTS

The terminology used herein is for the purpose of describing particular embodiments only, and is not intended to limit the scope of the present invention. As used throughout this disclosure, the singular forms “a,” “an,” and “the” include plural reference unless the context clearly dictates otherwise. Thus, for example, a reference to “a solid oxide fuel cell” includes a plurality of such fuel cells in a stack, as well as a single cell, and a reference to “an anode” is a reference to one or more anodes and equivalents thereof known to those skilled in the art or later discovered, and so forth.

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods, devices, and materials are now described. All publications mentioned herein are cited for the purpose of describing and disclosing the various anodes, electrolytes, cathodes, and other fuel cell components that are reported in the publications and that might be used in connection with the invention. Nothing herein is to be construed as an admission that the invention is not entitled to antedate such disclosures by virtue of prior invention.

Generally, an SOFC includes an air electrode (cathode), a fuel electrode (anode), and a solid oxide electrolyte provided between these two electrodes. In a SOFC, the electrolyte is in solid form. Typically, the electrolyte is made of a nonmetallic ceramic, such as dense yttria-stabilized zirconia (YSZ) ceramic, that is a nonconductor of electrons, which ensures that the electrons must pass through the external circuit to do useful work. As such, the electrolyte provides a voltage buildup on opposite sides of the electrolyte, while isolating the fuel and oxidant gases from one another. The anode and cathode are generally porous, with the cathode oftentimes being made of doped lanthanum manganite. In the solid oxide fuel cell, hydrogen or a hydrocarbon is commonly used as the fuel and oxygen or air is used as the oxidant.

The SOFC of the present invention can include any solid electrolyte and any cathode made using techniques disclosed in the art. The present invention is not limited to any particular material used for the electrolyte or cathode, nor is it particularly limited to their respective methods of manufacture. The invention is not limited to any particular number of fuel cells arranged in any manner to provide the requisite power source.

In a similar manner, the invention is not particularly limited to any design of the SOFC. Several different designs for solid oxide fuel cells have been developed, including, for example, a supported tubular design, a segmented cell-in-series design, a monolithic design, and a flat plate design. All of these designs are documented in the literature, including, for example, those described in Minh, “High-Temperature Fuel Cells Part 2: The Solid Oxide Cell,” Chemtech., 21:120-126 (1991).

The tubular design usually comprises a closed-end porous zirconia tube exteriorly coated with electrode and electrolyte layers. The performance of this design is somewhat limited by the need to diffuse the oxidant through the porous tube. Westinghouse has numerous U.S. patents describing fuel cell elements that have a porous zirconia or lanthanum strontium manganite cathode support tube with a zirconia electrolyte membrane and a lanthanum chromate interconnect traversing the thickness of the zirconia electrolyte. The anode is coated onto the electrolyte to form a working fuel cell tri-layer, containing an electrolyte membrane, on top of an integral porous cathode support or porous cathode, on a porous zirconia support. Segmented designs proposed since the early 1960s (Minh et al., Science and Technology of Ceramic Fuel Cells, Elsevier, p. 255 (1995)), consist of cells arranged in a thin banded structure on a support, or as self-supporting structures as in the bell-and-spigot design.

A number of planar designs have been described which make use of freestanding electrolyte membranes. A cell typically is formed by applying single electrodes to each side of an electrolyte sheet to provide an electrode-electrolyte-electrode laminate. Typically these single cells are then stacked and connected in series to build voltage. Monolithic designs, which characteristically have a multi-celled or “honeycomb” type of structure, offer the advantages of high cell density and high oxygen conductivity. The cells are defined by combinations of corrugated sheets and flat sheets incorporating the various electrode, conductive interconnect, and electrolyte layers, with typical cell spacings of 1-2 mm for gas delivery channels.

U.S. Pat. No. 5,273,837 describes sintered electrolyte compositions in thin sheet form for thermal shock resistant fuel cells. The method for making a compliant electrolyte structure includes pre-sintering a precursor sheet containing powdered ceramic and binder to provide a thin flexible sintered polycrystalline electrolyte sheet. Additional components of the fuel cell circuit are bonded onto that pre-sintered sheet including metal, ceramic, or cermet current conductors bonded directly to the sheet as also described in U.S. Pat. No. 5,089,455. U.S. Patent No. 5,273,837 describes a design where the cathodes and anodes of adjacent sheets of electrolyte face each other and where the cells are not connected with a thick interconnect/separator in the hot zone of the fuel cell manifold. These thin flexible sintered electrolyte-containing devices are superior due to the low ohmic loss through the thin electrolyte as well as to their flexibility and robustness in the sintered state.

Another approach to the construction of an electrochemical cell is disclosed in U.S. Pat. No. 5,190,834 Kendall. The electrode-electrolyte assembly in that patent comprises electrodes disposed on a composite electrolyte membrane formed of parallel striations or stripes of interconnect materials bonded to parallel bands of electrolyte material. Interconnects of lanthanum cobaltate or lanthanum chromite bonded to a yttria stabilized electrolyte are suggested. The SOFC of the present invention may be prepared using any of the techniques described above to provide the desired design, albeit a tubular cell, a monolithic cell, a flat plate cell, and the like. Using the guidelines provided herein, those skilled in the art will be capable of fabricating a SOFC including the inventive anode having any desired design configuration.

The invention preferably includes an anode, a method of making the anode, and a solid oxide fuel cell containing the anode. The inventive anode comprises a porous ceramic material, at least an additional ceramic material that may be the same or different form the porous ceramic material, a metal, or both, and at least one carbonaceous compound formed by exposing the anode material to a hydrocarbon having more than one carbon atom. It is preferred that if a metal is employed in the anode, that it is employed in amounts less than 20% by weight, based on the total weight of the anode, more preferably less than about 18%, even more preferably less than about 15% even more preferably less than about 10%, and most preferably less than about 8% by weight.

The anode materials of the present invention may contain no metallic element. In this regard, the anode preferably is comprised of stabilized YSZ impregnated with another ceramic. Preferred ceramics for use in the invention include, but are not limited to ceria, doped ceria such as Gd or Sm-doped ceria, LaCrO₃, SrTiO₃, Y-doped SrTiO₃, Sr-doped LaCrO₃, and mixtures thereof. It is understood that the invention is not limited to these particular ceramic materials, and that other ceramic materials may be used in the anode alone or together with the aforementioned ceramic materials. In addition, materials other than stabilized YSZ may be used as the porous ceramic material, including Gc- and Sm-doped ceria (10 to 100 wt %), Sc-doped ZrO₂ (up to 100 wt %), doped LaGaMnOₓ, and other electrolyte materials.

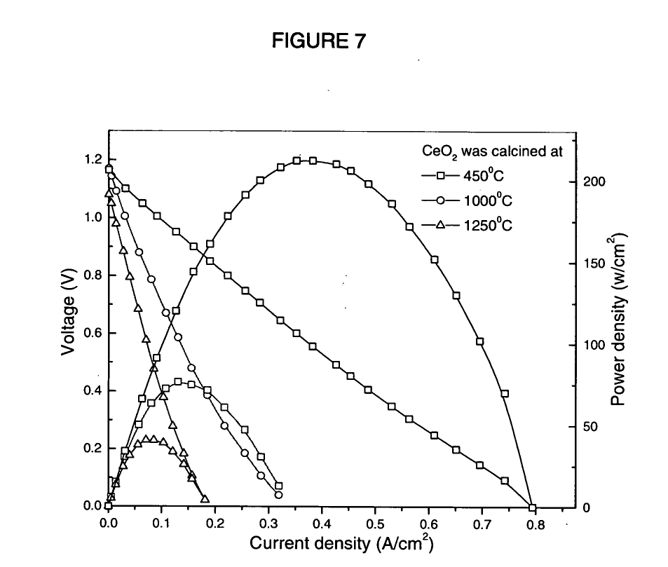

The inventors also have found that the addition of ceria to the anode improves performance. The high-temperature calcination utilized in the anode preparation, however, typically causes the ceria to react with YSZ, as a result of which performance is not enhanced to the extent which could be possible if formation of ceria-zirconia did not occur. FIG. 7 shows the effect the calcination temperature can have on a Cu-ceria-YSZ anode prepared by addition of Cu to a ceria-YSZ anode that had been heated to various temperatures in air. As shown in FIG. 7, the higher calcination temperatures decreased the performance of the anodes. It therefore is preferred in the present invention to prepare the anodes at temperatures lower than conventional calcination temperatures.

The anode of the SOFC also contains carbonaceous deposits that are formed by exposing the anode to a hydrocarbon having greater than one carbon atom. Preferably, the anode is exposed to butane, which provides superior enhancement when compared to exposure to methane. The anode materials preferably are exposed to the hydrocarbon at temperatures within the range of from about 500 to about 900° C., more preferably from about 600 to about 800° C., and most preferably at about 700° C. The exposure to the hydrocarbon can last anywhere from about 1 minute to 24 hours, preferably, from about 5 minutes to about 3 hour, and most preferably from about 10 minutes to about 1 hour, 30 minutes. The anode materials can be exposed to the hydrocarbon once, or numerous times.

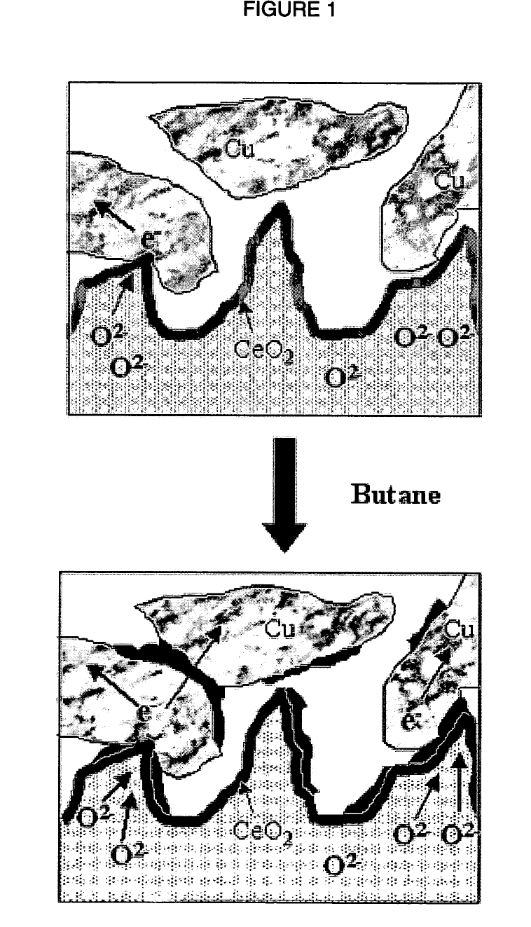

The inventors surprisingly discovered that the amount of carbon formed on the anode reaches an equilibrium and consequently, the carbon formed does not completely coat the anode to render it ineffective. While not intending on being bound by any theory, the inventors believe that minor amounts of hydrocarbon residues are deposited on the surface of the anode and fill the gaps between the electron-conducting particles when metals or conductive oxides are included in the anode composition, or provides a conductive film in the absence of these other components. As shown in FIG. 1, there may be gaps between the conductive particles and the surface of the anode that lead to decreased conductivity. After treatment with a hydrocarbon having more than one carbon, e.g., butane, the hydrocarbon residues that are formed fill the gaps and improve the conductivity to allow the flow of electrons from the surface of the anode to the conductive particles.

This surprising discovery and enhanced performance is more pronounced when the amount of conductive particles employed in the anode material is less than about 20% by weight, based on the weight of the anode. When the amount is greater than about 20%, the surface of the anode likely will be sufficiently “coated” with the conductive particles . When the amount is less than about 20%, some of the conductive particles may not be initially contacted to the outside circuit and thus, are unable to conduct electrons away from the three-phase boundary (e.g., stabilized YSZ, ceria, and metal, such as copper) as shown in the upper portion of FIG. 1. Accordingly, the anodes of the present invention preferably include less than about 20% by weight metal or other conductive component, and more preferably, less than about 15%.

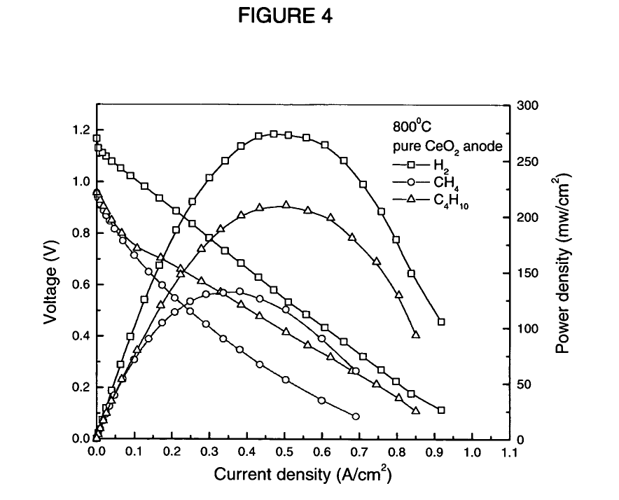

One of the features of an embodiment of the invention is to pre-treat the anode material by contacting it with a hydrocarbon having more than one carbon atom at an elevated temperature for a period of time sufficient to form carbonaceous deposits on the anode. The type of carbonaceous materials formed may have an effect on the conductivity of the SOFC. For example, the inventors have found that the performance of the SOFC cell was improved when treated with butane at 800° C., when compared to the same SOFC cell that was treated with methane. The performance curves are shown in FIG. 4.

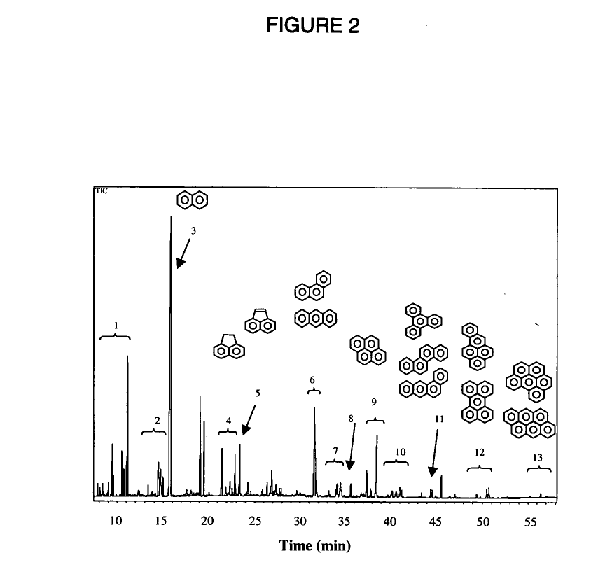

To determine the types of carbon compounds formed, the inventors therefore exposed a copper plated stainless steel substrate to n-butane at 700° C. for 24 hours to form carbonaceous deposits. These deposits were found to be soluble in toluene, so that they could be analyzed using gas chromatography, with the results shown in FIG. 2. As shown therein, the carbon materials formed are polyaromatic compounds, preferably fused benzene rings containing anywhere from 2 to 6 benzene rings fused together. These polyaromatic compounds are distinct from the carbon fibers that are typically formed when using Ni, Co, and Fe in the anode (Toebes, M. L., et al., Catalysis Today, 2002). The polyaromatic compounds have a low but finite vapor pressure at 700° C.

The performance enhancements observed in accordance with the invention upon exposure of the anodes to hydrocarbon fuels is believed to be due to improved connectivity in the electron-conducting phase based in part on the observation that the addition of more conductive component such as a metal (e.g, Cu) leads to similar enhancements. FIG. 1 is a schematic drawing of what the inventors believe occurs in the region near the three-phase boundary (TPB) upon exposure of the metal (e.g, Cu)-based anodes to hydrocarbons. For lower metal contents, some of the metal particles are initially not connected to the outside circuit and are therefore unable to conduct electrons away from the TPB (see, the upper portion of FIG. 1). The addition of hydrocarbon “residues” likely fills the gaps between the metal particles and provides sufficient conductivity to allow the flow of electrons (see, the lower portion of FIG. 1).

What is surprising is that small amounts of hydrocarbon residue are apparently sufficient to increase the conductivity substantially. Although the inventors do not know precisely what the chemical form of the residue might be, the quantity necessary to significantly enhance performance appears to correspond to no more than about 10 wt %, preferably no more than about 5 wt %, and most preferably no more than about 2 wt %. If the density for the residue is assumed to be about 1 g/cm³, a value typical for hydrocarbons, the volume fraction of this residue is less than 5%, based on the volume of the anode. If the density for the residue is assumed to be more similar to that of graphite, the volume occupied by the residue would be even lower.

By comparison, the minimum metal content for metal-containing cermet anodes is reported to be about 30 vol % (Dees, D. W., et al., J. Electrochem. Soc., 134, 2141 (1987)). The metal contents used in the inventive anodes are much lower. Even a sample containing 30 wt % Cu only has a volume fraction of Cu of about 19%. The addition of an extra 5 vol % carbon would not seem to be sufficient to increase the fraction of the electron-conductive phase enough to make such a large difference in performance. A partial explanation for the unexpected behavior may lie in the structure of the sample anodes. In a preferred embodiment of the invention, since Cu is added to the porous YSZ material after the pore structure has been established, the anode structure is likely to be much less random than cermets prepared by more conventional methods. Therefore, the deposits may simply coat the walls of the pores and enhance conductivity much more effectively than would the random addition of an electron-conductive phase.

The inventors also have shown herein that the anode deposits are “tar-like,” rather than graphitic. In addition to the chromatographic results from FIG. 2, the inventors observed no noticeable difference in the amounts deposited on pure YSZ, and YSZ with Cu and ceria added, and it would appear that these deposits form through free-radical decomposition, rather than by any surface-catalyzed processes. Based on temperature-programmed oxidation (TPO) results, the polyaromatic deposits are much more reactive than graphite. Hydrocarbons are only electronic conductors when they contain highly conjugated olefinic or aromatic groups, so it is believed that the polyaromatic nature of these compounds is beneficial to the invention.

A feature of various embodiments of the invention is that it is possible to operate direct-oxidation fuel cell with low metal contents (e.g, less than about 20% by weight metal all the way down to no metal) and still obtain reasonable performance. At low metal contents, re-oxidation of the metal (e.g., Cu) does not destroy the cell. In addition, it should be possible to counter the effects of Cu sintering, which is likely to be a problem for operation at higher temperatures due to the low melting temperature of Cu.

Another feature of an embodiment of the invention is a SOFC that comprises an air electrode (cathode), a fuel electrode (anode), and a solid oxide electrolyte disposed at least partially between these two electrodes. In a SOFC, the electrolyte is in solid form. Any material now known or later discovered can be used as the cathode material and as the electrolyte material. Typically, the electrolyte is made of a nonmetallic ceramic, such as dense yttria-stabilized zirconia (YSZ) ceramic, the cathode is comprised of doped lanthanum manganite. In the solid oxide fuel cell, hydrogen or a hydrocarbon is commonly used as the fuel and oxygen or air is used as the oxidant. Other electrolyte materials useful in the invention include Sc-doped ZrO₂, Gd- and Sm-doped CeO₂, and LaGaMnOx. Cathode materials useful in the invention include composites with Sr-doped LaMnO₃, LaFeO₃, and LaCoO₃, or metals such as Ag.

Another feature of an embodiment of the invention includes a method of making the above-described anode. In accordance with the method, it is preferred first to form a powder of yttria stabilized zirconia (YSZ), and then tape casting the powder to form a two-layer, green tape of YSZ (one layer for the anode and the other for the electrolyte). The two-layer green tape then preferably is sintered at temperatures within the range of from about 1,200 to about 1,800° C., preferably from about 1,350 to about 1,650° C., and most preferably from about 1,500 to about 1,550° C. to form a porous YSZ material. The porosity of the porous material preferably is within the range of from about 45% to about 90%, more preferably within the range of from about 50% to about 80% and most preferably about 70%, by water-uptake measurements, (Kim, H., et al., J. Am. Ceram. Soc., 85, 1473 (2002)). Sintering the two-layer tape in this manner preferably results in a YSZ wafer having a dense side, approximately 40 to about 80 μm thick, more preferably about 60 μm thick, supported by a porous layer, approximately 400 to about 800 μm thick, more preferably about 600 μm thick.

The cathode can be formed by applying the cathode composition (e.g, a mixture of YSZ and La_{0.8}Sr_{0.2}MnO₃) as a paste onto the dense side of the wafer and then calcining the cathode at a temperature within the range of from about 1,000 to about 1,300° C., more preferably within the range of from about 1,100 to about 1,200° C., and most preferably about 1,130° C.

The anode preferably is formed by impregnating the porous YSZ portion of the wafer with an aqueous solution (or other solution such as a solvent containing solution) containing an additional ceramic material that may be the same or different from the porous ceramic material, and optionally a metal. For example, the porous YSZ portion can be impregnated with an aqueous solution of Ce(NO₃)₃.6H₂O and then calcined at a temperature sufficient to decompose the nitrate ions. Preferably, calcination is carried out at a temperature within the range of from about 300 to about 700° C., more preferably from about 400 to about 600° C., and most preferably about 450° C. An aqueous solution containing the metal (e.g., Cu(NO₃)₂.3H₂O) then may be applied to the porous layer and calcined at or about the same temperature.

The amount of additional ceramic material employed in the anode that may be the same or different from the porous ceramic material preferably ranges from about 5 to about 30% by weight, more preferably from about 7 to about 25%, and most preferably about 10 to about 15% by weight, based on the total weight of the anode.

The invention now will be explained with reference to the following non-limiting examples

### EXAMPLES

Making the SOFC

The methods used to prepare and test the solid oxide fuel cells containing Cu-cermet anodes are the same as those described in Gorte, R. J., et al., Adv. Materials, 12, 1465 (2000), and Park, S., et al., J. Electrochem. Soc., 148, A443 (2001). Because oxides of Cu melt at temperatures lower than that required for sintering of the oxide components, the fabrication procedure involved preparing a porous YSZ material, impregnating this porous material with Cu salt, and finally reducing the salt to metallic Cu.

In the first step, the dense electrolyte layer and the porous YSZ material were prepared simultaneously by tape-casting methods. A two-layer, green tape of YSZ (yttria-stabilized zirconia, Tosoh, 8 mol % Y₂O₃, TZ-84) was made by casting a tape with graphite and poly-methyl methacrylate (PMMA) pore formers over a green tape without pore formers. Firing the two-layer tape to 1800 K resulted in a YSZ wafer having a dense side, 60 μm thick, supported by a porous layer, 600 μm thick. The porosity of the porous layer was determined to be ˜70% by water-uptake measurements Kim, H., et al., J. Am. Ceram. Soc., 85, 1473 (2002). Next, a 50:50 mixture of YSZ and LSM (La_{0.8}Sr_{0.2}MnO₃, Praxair Surface Technologies) powders was applied as a paste onto the dense side of the wafer, then calcined to 1400 K to form the cathode. Third, the porous YSZ layer was impregnated with an aqueous solution of Ce(NO₃)₃.6H₂O and calcined to 723 K to decompose the nitrate ions and form CeO₂. The porous layer was then impregnated with an aqueous solution of Cu(NO₃)₂.3H₂O and again heated to 723 K in air to decompose the nitrates. All of the cells used in these examples contained 10 wt % CeO₂, and the Cu content was varied between 0 wt % and 30 wt %.

Electronic contacts were formed using Pt mesh and Pt paste at the cathode and Au mesh and Au paste at the anode. Each cell, having a cathode area of 0.45 cm², was sealed onto 1.0-cm alumina tubes using Au paste and a zirconia-based adhesive (Aremco, Ultra-Temp 516).

Testing the SOFC and Inventive and Comparative Anodes

The entire solid oxide fuel cell prepared above was placed inside a furnace and heated to 973 K at 2 K/min in flowing H₂. Hydrogen (H₂), CH₄, propane, and n-butane were fed to the cell undiluted, while toluene and decane were fed as 75 mol % mixtures with N₂. All hydrocarbons, including those that are liquids at room temperature, were fed directly to the anode without reforming, as described in Kim, H., et al., J. Electrochem. Soc., 148, A693 (2001).

The performance at 973 K for each cell was measured by its V-I curves with n-butane and H₂ fuels, with impedance spectra providing additional information on selected samples. Since the cathodes and electrolytes were prepared in a similar manner in all cases, changes in the fuel-cell performance and in the impedance spectra can be attributed to changes in the anode. Since the fuel flow rates were always greater than 1 cm³/s at room temperature, the conversion of the hydrocarbon fuels was always less than 1%, so that water produced by the electrochemical oxidation reactions was negligible. The impedance spectra were obtained in galvanostatic mode at close to the open-circuit voltage (OCV), using a Gamry Instruments, Model EIS300.

The amount of carbon present in the SOFC anode after treatment in n-butane also was measured. To accomplish this, anode cermet samples were exposed to flowing n-butane in a quartz flow reactor at 973 K for various periods of time. The sample weight or the amount of CO and CO₂ that formed upon exposure to flowing O₂ were then measured. In the weight measurements, the sample temperature was ramped to 973 K in flowing He, exposed to flowing n-butane for a limited period, and then cooled in flowing He. Following longer exposures, the samples were flushed in flowing He at 973 K for 24 hrs before cooling.

In the second method for measuring carbon contents in the anode, samples were exposed to n-butane in the flow reactor at 973 K and flushed with He. The sample then was exposed to a flowing gas consisting of a 15% O₂-85% He mixture while monitoring the reactor effluent with a mass spectrometer. The amount of carbon in the sample was determined from the amounts of CO and CO₂ leaving the reactor. The type of carbon formed was also characterized by temperature-programmed oxidation (TPO) in a similar manner. In these measurements, a cermet sample was exposed to flowing n-butane at 973K for 30 min. The reactor was cooled to 298K in flowing He and again ramped to 973K at a rate of 10 K/min in a flowing gas mixture of 15% O₂-85% He.

In principle, TPO experiments carried out with a mass spectrometer would enable the calculation of carbon to hydrogen ratios as the detector should be able to determine the amount of hydrogen in the deposits; however, the background signal for water in our vacuum system was too high to allow accurate measurement of this quantity. A sample of 0.03 g of graphite powder (Alpha Aesar, conducting grade 99.995%) was placed in an identical reactor and heated in a 15% O₂-85% He stream at 10 K/min for comparison. SEM measurements of the graphite sample suggested that the particles were shaped as platelets, less than 10 μm in thickness.

Results of Initial Testing

The effect of treating the Cu-cermet anodes in a hydrocarbon fuel at 973 K is demonstrated by an experiment where the power density was measured as a function of time while changing the fuel from H₂, to n-butane, and back to H₂. The fuel cell was maintained at 0.5 V, and fuel cell contained an anode having 20 wt % Cu. The anode had initially been exposed to H₂ for a period of several hours and the cell exhibited a power density of only 0.065 W/cm². Upon changing the feed to pure n-butane, the power density increased to a value of 0.135 W/cm² following a brief transient period. After operating the cell in n-butane for 20 min, the feed was switched to pure H₂ and the power density increased to 0.21 W/cm², a factor of 3.2 greater than the power density that had been observed prior to exposing the anode to n-butane.

This enhancement of cell performance after exposure to n-butane was found to be fully reversible upon re-oxidation of the anode. Fuel cells were subjected to various pretreatments for a cell operating in pure H₂, with an anode comprising 10 wt % CeO₂ and 15 wt % Cu. Data were taken for the cell after the initial reduction of the anode in H₂, after exposing the anode to pure n-butane for 60 min, then after exposing it to 15% O₂ in He for 30 min and, finally, after a further 60 min exposure to n-butane. Following the oxidation cycle, the anode was held in H₂ for 30 min before recording the data. Initially, the maximum power density in H₂ was 0.045 W/cm². This increased to 0.16 W/cm² after a one-hour exposure to n-butane, which is similar to the results obtained above fro the 20 wt % Cu anode. Following oxidation in 15% O₂ and reduction in H₂, the performance curve returned to its initial value. Finally, exposing the cell to n-butane once again increased the performance curve to its higher value.

The enhanced performance upon exposure to n-butane and the reversibility upon re-oxidation were observed from the total cell resistances, which are approximately 6 Ω·cm² before treatment in n-butane and 1.4 Ω·cm² after treatment in n-butane. Of additional interest, the ohmic resistance of the cell, R₁₀₆, measured by the high-frequency intercept with the real axis, decreases from ˜2.9 Ω·cm² to ˜0.6 Ω·cm² after n-butane treatment. Normally, R_{Ω} is associated with the conductivity of the electrolyte. Migration of charged species in mixed-conducting anodes and cathodes gives rise to an interfacial resistance, R_{I}, taken to be the difference between the high- and low-frequency intercepts with the real axis. R_{I}, too, decreases from more than 3 Ω·cm² to 1 Ω·cm² after treatment in n-butane.

It is believed that the initially poor connectivity between metal particles in the anode is based on the high initial ohmic resistance. R_{Ω} should be less than 1 Ω·cm² for the SOFC cell based on literature values for the conductivity of YSZ at 973 K and the thickness of the electrolyte. The fact that R_{Ω} initially is much larger than this implies that part of the ohmic resistance must be in the anode.

An obvious implication of the above conclusion is that increased Cu contents should improve the initial performance and possibly reduce the enhancement observed with treatment in hydrocarbon fuels. This in fact occurred. V-I curves were established for cells containing 5%, 10%, 20%, and 30% copper, before and after exposure to n-butane for 30 min. The ceria content and YSZ structure were identical in all of the cells. The initial performance for cells with a low Cu content is poor, but increases dramatically upon exposure to n-butane. The maximum power density increased by a factor of 3.5 for the two cases including 5% and 10% copper. The data for the cell with 20% copper showed a more modest improvement, with the maximum power density increasing by a factor of only 2.5 after treatment with n-butane. Finally, data for the cell with 30% copper showed only small changes in the performance curves after exposure to n-butane. Thus, these data show that the enhancement achieved by treating the anode with hydrocarbons having greater than one carbon atom is greater when the amount of metal in the anode is lower, although the initial performance is greater, as would be expected.

Impedance spectra measured at OCV in H₂ were taken on the same cells as described above. Prior to treatment with n-butane, there is a steady decrease in both R_{Ω} and R_{I} as the Cu content increased. The changes in these values are particularly large when going from 10 wt % Cu to 20 wt % Cu. Even after treatment with n-butane, R_{Ω} decreases steadily, going from ˜1.0 Ω·cm² to ˜0.5 Ω ·cm². The changes in R_{Ω} would therefore suggest that connectivity of the electronic conductors in the anode increase with both the addition of Cu and with n-butane treatment, but that addition of Cu is more effective. However, it is interesting to notice that R_{I} in the 30 wt % Cu cell remains relatively large after treatment in n-butane. Indeed, after treatment in n-butane, the 30 wt % Cu cell had the largest R_{I} of all the four cells investigated.

Assuming that the enhanced anode conductivity is due to deposition of hydrocarbons in the anode, the increase in the mass of various samples after they had been heated in flowing n-butane at 973 K in a tubular reactor was measured. First, no significant differences in the mass changes for a porous YSZ material with no added materials, and for a porous YSZ material having 20 wt % Cu and 10 wt % CeO₂ added were observed. For the Cu cermet, the weight changes were 1.3% after 10 min, 2.1% after 30 min, and 4.5% after 24 hrs. The carbon content based on the production of CO and CO₂ formed by reaction with the 15% O₂-85% He mixture was 2.1% after 10 min and 4.0% after 20 min, but this number also included any carbon formed on the reactor walls. Since the performance increase following treatment in n-butane occurred in much less than 10 min and was not lost upon exposure to flowing H₂, the small carbon contents observed in these measurements suggested that small amounts of hydrocarbon are needed to increase the connectivity in the anode. This is particularly interesting given that relatively large amounts of Cu need to be added to achieve the same connectivity.

To determine how hydrocarbons other than n-butane would affect the anode, the performance of a cell made with 20 wt % Cu and 10 wt % CeO₂ in H₂ at 973 K after exposing it to methane, propane, n-decane, and toluene was examined. Between measurements, the cell was exposed to a 10% O₂-90% N₂ stream to reverse any enhancements caused by the previous fuel. With n-decane and toluene, enhanced performance was observed almost instantly after exposing the fuel to the anode; and the performance enhancements for n-butane, n-decane, and toluene were also indistinguishable. For propane, a similar enhancement again was observed but the enhancement occurred much more gradually. It was necessary to expose the cell to propane for more than 10 min to achieve the maximum power density. With methane, however, no enhancement was observed, even after several hours. Because methane exhibited a much lower tendency to undergo free-radical reactions compared to the other hydrocarbons examined, with propane the next least reactive, these results indicate that any fuel that causes hydrocarbons to form in the anode should lead to similar performance enhancements.

The nature of the anode deposits using TPO carried out in a He-O₂ mixture was investigated. Data was obtained that showed CO₂ (m/e=44) and O₂ (m/e=32) signals from TPO curves for a YSZ cermet impregnated with 20% Cu and 10% CeO₂ in the manner described above, that was exposed to n-butane for 30 minutes at 973 K before being cooled to room temperature in flowing He. The results show that CO₂ is formed and O₂ consumed in a narrow range of temperatures, between about 623 and 723 K. An additional O₂ consumption peak is observed at 773 K that may be due to re-oxidation of bulk Cu, although some of the O₂ consumed in the lower peak also likely corresponds to Cu oxidation. Water formation was not observed, but more O₂ is consumed than can be accounted for by CO₂ production and Cu oxidation. The additional O₂ consumption is probably due to water formation but is difficult to quantify. The likely formation of water, together with the fact that the deposits react at low temperatures, strongly suggests that the carbonaceous deposits on the anode are not graphitic. A TPO curve for a graphite-powder sample using the same experimental conditions reveals that CO₂ production does not occur until above 973 K, a value similar to that reported by Wang, P., et al., Appl. Catal. A, 231, 35 (2002). Some of the difference between the graphite and the anode deposits could be due to surface-area effects and the presence of ceria in the anode; however, neither the presence of a catalyst nor the increased surface area would be expected to give a temperature increase of more than 300 degrees.

Finally, to determine whether the oxygen-ion flux through the electrolyte might potentially “clean” the anode, the cell was examined under OCV conditions at 973 K in the presence of 100% flowing n-butane. V-I curves were obtained for a cell with 20 wt % Cu using n-butane as the fuel. The results reveal that there appears to be a slight decrease in the maximum power density after a 24-hr exposure but the differences are not significant.

During the course of this experiment, the OCV measurements showed interesting trends. Initially, the OCV in n-butane was greater than 1.0 V but it quickly fell to a value of 0.85 V. After ˜4 hrs, the cell was briefly shorted, and then the OCV measured. Again, the OCV started at more than 1.0 V and rapidly decreased to 0.85 V.

These experiments suggest that there is a hydrocarbon layer at the three-phase boundary in the direct-oxidation experiments (see, FIG. 1). Since the OCV for these cells with H₂ as the fuel was 1.1 V, it seems unlikely that leaks can account for the low OCV in n-butane at steady state. Also, the theoretical OCV for complete combustion of n-butane to CO₂ and H₂O is 1.12 V at standard conditions and 973 K. While the oxidation of carbon and most hydrocarbons should yield an OCV of greater than 1 V, partial oxidation reactions would result in lower standard potentials. For example, the standard potential for oxidation of n-butane to n-butanal is 0.87 V at 973 K. Other redox couples, such as oxidation of Ce₂O₃, cannot account for an OCV of 0.85 V. Therefore, the most likely explanation for the OCV data described in these examples is that equilibrium is established with partial oxidation reactions. The transients in the OCV are probably due to slow changes in the chemical structure of the carbonaceous layer on or within the anode.

Preparing and Testing Inventive Ceramic Anodes and SOFC

The methods used to prepare and test the solid oxide fuel cells containing Cu-cermet anodes are the same as those described in Gorte, R. J., et al., Adv. Materials, 12, 1465 (2000), and Park, S., et al., J. Electrochem. Soc., 148, A443 (2001). In the first step, the dense electrolyte layer, a porous YSZ material, and a cathode formed on the dense electrolyte layer were prepared in the same manner as described above. The porous YSZ layer then was impregnated with an aqueous solution of Ce(NO₃)₃.6H₂O, and calcined to 723 K to decompose the nitrate ions and form CeO₂. The SOFC cells used in this example contained 10 wt % CeO₂, and no metal.

Electronic contacts were formed using Pt mesh and Pt paste at the cathode and Au mesh and Au paste at the anode. Each cell, having a cathode area of 0.45 cm², was sealed onto 1.0-cm alumina tubes using Au paste and a zirconia-based adhesive (Aremco, Ultra-Temp 516).

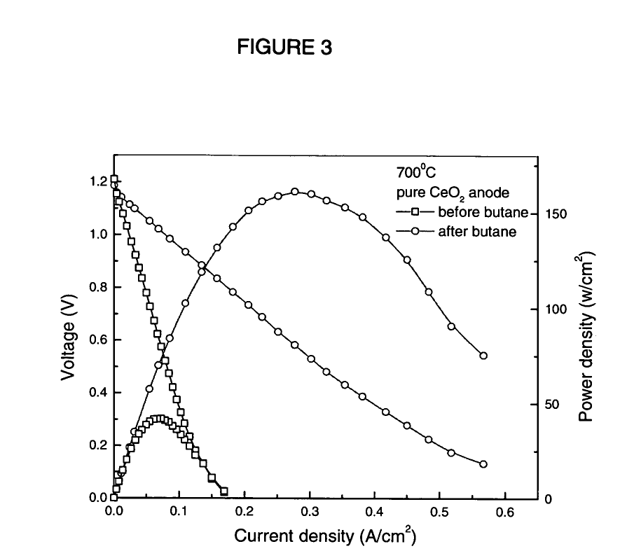

Each of the above prepared SOFCs were tested as described above for performance in H₂ fuel, both before and after contacting with hydrocarbons. The results are shown in FIGS. 3-6. FIG. 3 shows that a very large enhancement can be obtained for a ceria/YSZ anode in which there is no Cu. While the performance of this cell is not as high as that of cells made with Cu, the performance is quite good. This cell also performed well at 800° C., as shown in FIG. 4.

The mechanism for enhancement may be explained by results shown in FIG. 2. A stainless steel plate was coated with copper and then the surface was contacted with flowing n-butane at 700° C. for 24 hrs. The contact produced a tar-like carbonaceous residue on the surface. This residue was soluble in toluene and was subsequently analyzed in a GC-Mass Spec. As shown in FIG. 2, the carbonaceous tar comprises polyaromatics having anywhere from 2 to 6 fused aromatic rings. These polyaromatics would be expected to be highly conductive. the inventors found that surprisingly, the amount of carbonaceous tar that forms was self-limiting, so that the surface of the anode is not poisoned.

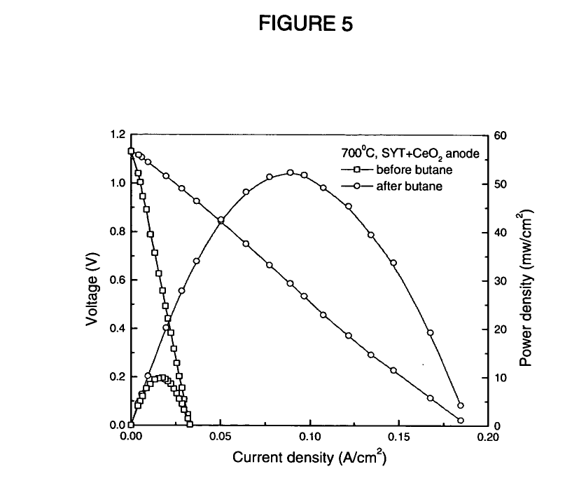

Additional SOFCs were prepared that contained ceramic anodes in a manner similar to that described above. Instead of preparing the anode by impregnating porous YSZ with a ceria solution, the anode was prepared by tape casting YST (Y-doped SrTiO₃) with pore formers, then impregnating the porous YST with ceria to a level of 10 wt %. The electrolyte was YSZ (60 microns) and the cathode an LSM-YSZ composite, prepared as described above. This SOFC was tested in flowing H₂, before and after exposure to n-butane as described above, and the results are shown in FIG. 5. As shown in FIG. 5, superior performance was achieved by contacting the ceramic anode to butane, thus forming carbonaceous deposits on the anode.

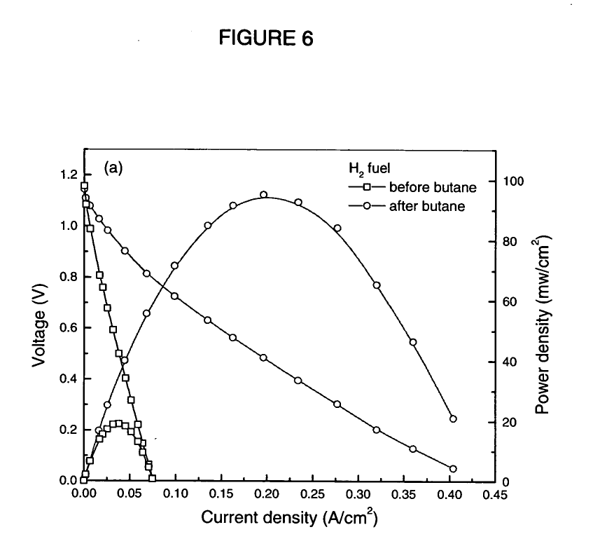

Another SOFC was prepared by impregnating the porous YSZ with Sr-doped LaCrO₃, whereby the electrolyte and cathode were prepared in the same manner as described above. The SOFC was tested in flowing H₂, before and after exposure to n-butane as described above, and the results are shown in FIG. 6. As shown in FIG. 6, superior performance was achieved by contacting the ceramic anode to butane, thus forming carbonaceous deposits on the anode.

Other embodiments, uses, and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An anode comprising:
a porous ceramic material;
at least an additional ceramic material which may be the same or different from the porous ceramic material, a metal, or both; and
at least one carbonaceous compound formed by exposing the anode material to a hydrocarbon having more than one carbon atom.

2. The anode as claimed in claim 1, wherein the porous ceramic material is selected from the group consisting of YSZ, Gc- and Sm-doped ceria (10 to 100 wt %), Sc-doped ZrO₂ (up to 100 wt %), doped LaGaMnOₓ, and mixtures thereof.

3. The anode as claimed in claim 2, wherein the porous ceramic material is YSZ.

4. The anode as claimed in claim 1, wherein the anode contains a metal in an amount less than about 20% by weight, based on the total weight of the anode.

5. The anode as claimed in claim 4, wherein the amount of the metal is less than about 15% by weight, based on the total weight of the anode.

6. The anode as claimed in claim 4, wherein the amount of the metal is less than about 10% by weight, based on the total weight of the anode.

7. The anode as claimed in claim 1, wherein the anode comprises substantially no metal.

8. The anode as claimed in claim 1, wherein the additional ceramic material is selected from the group consisting of ceria, doped ceria such as Gd or Sm-doped ceria, LaCrO₃, SrTiO₃, Y-doped SrTiO₃, Sr-doped LaCrO₃, and mixtures thereof.

9. The anode as claimed in claim 8, wherein the additional ceramic material is ceria.

10. The anode as claimed in claim 1, wherein the at least one carbonaceous compound is a polyaromatic compound.

11. A method of making an anode comprising:
forming a porous ceramic material;
adding at least an additional ceramic material that may be the same as or different from the porous ceramic material, a metal, or both to the porous ceramic material; and
contacting the resulting mixture with a hydrocarbon having greater than one carbon atom for a period of time sufficient to form carbonaceous deposits on or in the anode.

12. The method according to claim 11, therein the mixture of the porous ceramic material and the at least an additional ceramic material, metal or both are heated at a temperature within the range of from about 300 to about 700° C. prior to contacting with the hydrocarbon.

13. The method according to claim 11, wherein the porous ceramic material is prepared by:
forming a two-layer green tape comprising YSZ; and
sintering the green tape at a temperature within the range of from about 1,350 to about 1,650° C.

14. The method according to claim 11, wherein contacting the mixture of porous ceramic material and the at least an additional ceramic material, metal or both with a hydrocarbon having more than one carbon atom comprises contacting the mixture with n-butane at about 600 to about 800° C. for about 1 minute to about 24 hours.

15. A solid oxide fuel cell comprising:
the anode of claim 1;
a cathode; and
an electrolyte disposed at least partially between the cathode and the anode.

16. The solid oxide fuel cell as claimed in claim 15, wherein the cathode is comprised of a material selected from the group consisting of Sr-doped LaMnO₃, LaFeO₃, LaCoO₃, metals selected from Fe and Ag, and mixtures thereof.

17. The solid oxide fuel cell as claimed in claim 15, wherein the electrolyte is selected from the group consisting of YSZ, Sc-doped ZrO₂, Gd- and Sm-doped CeO₂, LaGaMnOx, and mixtures thereof.

18. The solid oxide fuel cell as claimed in claim 15, wherein the porous ceramic material of the anode is selected from the group consisting of YSZ, Gc- and Sm-doped ceria (10 to 100 wt %), Sc-doped ZrO₂ (up to 100 wt %), doped LaGaMnOₓ, and mixtures thereof.

19. The solid oxide fuel cell as claimed in claim 18, wherein the porous ceramic material is YSZ.

20. The solid oxide fuel cell as claimed in claim 15, wherein the anode contains a metal in an amount less than about 10% by weight, based on the total weight of the anode.

21. The solid oxide fuel cell as claimed in claim 15, wherein the anode comprises substantially no metal.

22. The solid oxide fuel cell as claimed in claim 15, wherein the additional ceramic material in the anode is selected from the group consisting of ceria, doped ceria such as Gd or Sm-doped ceria, LaCrO₃, SrTiO₃, Y-doped SrTiO₃, Sr-doped LaCrO₃, and mixtures thereof.

23. The solid oxide fuel cell as claimed in claim 22, wherein the additional ceramic material is ceria.

24. The solid oxide fuel cell as claimed in claim 23, wherein the at least one carbonaceous compound in the anode is a polyaromatic compound.

25. A method of making a solid oxide fuel cell comprising:
forming a two-layer green tape comprising an electrolyte material;
sintering the green tape at a temperature within the range of from about 1,350 to about 1,650° C. to form a porous material of electrolyte material having a dense side and a porous side;
forming a cathode on the dense side of the electrolyte material by applying a cathode composition to the dense side and calcining;
forming an anode by impregnating the porous side of the porous material of electrolyte material with a ceramic material, a metal, or both; and
contacting the resulting anode with a hydrocarbon having greater than one carbon atom for a period of time sufficient to form carbonaceous deposits on the matrix.

26. The method according to claim 25, wherein calcination of the cathode material takes place at a temperature within the range of from about 1,000 to about 1,300° C.

27. The method according to claim 25, wherein forming the anode further comprises heating the mixture of the porous electrolyte material and the at least a ceramic material, metal or both at a temperature within the range of from about 300 to about 700° C.

28. The method according to claim 25, wherein the green tape is sintered at a temperature within the range of from about 1,500 to about 1,550° C.

29. The method according to claim 25, wherein contacting the mixture of porous electrolyte material and the at least a ceramic material, metal or both with a hydrocarbon having more than one carbon atom comprises contacting the mixture with n-butane at about 600 to about 800° C. for about 1 minute to about 24 hours.

30. The method according to claim 25, wherein the electrolyte material is YSZ.
